(19) United States
(12) Patent Application Publication
(10) Pub. No.: US 2008/0055729 A1
(43) Pub. Date: Mar. 6, 2008

(54) Reducing reflections in image sensors

(75) Inventors: Jiutao Li, Boise, ID (US); Jin Li, Meridian, ID (US); Ulrich Boettiger, Boise, ID (US)

Correspondence Address: LEFFERT JAY & POLGLAZE, P.A.;Attn: Tod Myrum, P. O. Box 581009, Minneapolis, MN, 55402, US

(73) Assignee: Micron Technology, Inc.

(21) Appl. No.: 11/511,039

(22) Filed: Aug. 28, 2006

(51) Int. Cl. G02B 27/00; G02B 13/14

(52) U.S. Cl. 359/601; 359/355

(57) ABSTRACT

Methods and apparatus are provided. An image sensor has an array of light sensing elements and a transparent cover overlying the array of light sensing elements. The cover has a first roughened surface facing the array of light sensing elements and a second roughened surface facing away from the light sensing elements.

### TECHNICAL FIELD OF THE INVENTION

The present invention relates generally to image sensors and in particular the present invention relates to reducing reflections in image sensors.

### BACKGROUND OF THE INVENTION

When electromagnetic radiation, such as light, is received at an interface between media with differing indices of refraction, such as glass and air, reflections occur. Such reflections are typically undesirable for applications involving projectors, where reflections act to reduce contrast ratios, applications involving imagers, e.g., of digital cameras or the like, where reflections act to reduce the amount of light received at an image sensor of an imager, etc.

A typical imager includes image sensors that use Charged Coupled Device (CCD) systems, Complementary Metal-Oxide Semiconductor (CMOS) systems, or other systems to convert light received thereat to electrical signals. Image sensors are typically packaged to protect delicate components thereof and to provide external electrical contacts. For example, a transparent cover, e.g., of glass, may be formed overlying an image sensor, so as to form a gas- (e.g., an air-) containing region between the cover and the image sensor. This results in a first cover-air interface between a surface of the cover that faces the image sensor and the air in the air-containing region. Moreover, a second cover-air interface may exist between a surface of the cover that faces away from the image sensor and air exteriorly of the image sensor.

During operation, incident light is received, e.g., from an image to be captured, at the second cover-air interface. Owing to the difference between the indices of refraction of the air and cover, a portion of the incident light, e.g., about four percent, is reflected from the second cover-air interface, and a portion of the incident light, e.g., about 96 percent, is transmitted through the cover. When the portion of the incident light that is transmitted through the cover reaches the first cover-air interface, a portion, e.g., about four percent, is reflected from the first cover-air interface, owing to the difference between the indices of refraction of the air and cover, and a portion is transmitted through the air-containing region, e.g., about 96 percent of the portion transmitted through the cover or about 92 percent of the incident light, and is received at the image sensor.

One method of reducing the reflection that occurs at an interface between a solid and a gas, such as an interface between a transparent cover of an imager and air, involves applying an anti-reflective coating to the solid. However, such coatings are often expensive.

For the reasons stated above, and for other reasons stated below which will become apparent to those skilled in the art upon reading and understanding the present specification, there is a need in the art for alternatives for reducing the reflection that occurs at an interface between media with differing indices of refraction.

### BRIEF DESCRIPTION OF THE DRAWINGS

FIG. 1 is a block diagram of an image sensor, according to an embodiment of the invention.

FIG. 2 is a cross-section of a portion of an image sensor, according to another embodiment of the invention.

FIG. 3 is a plan view of a roughened surface, according to another embodiment of the invention.

FIGS. 4A-4D are cross-sectional views of a portion of an image sensor at various stages of fabrication, according to another embodiment of the invention.

FIGS. 5A-5C are plan views illustrating different hole-patterns in a roughened surface, according to another embodiment of the invention.

FIG. 6 is a plan view of a portion of surface corresponding to the configuration of FIG. 4D, according to another embodiment of the invention.

FIG. 7 is a cross-sectional view of taken along line 7-7 of FIG. 6, according to another embodiment of the invention.

FIG. 8 is an isometric plan view of a roughened surface of a cover or a lens, according to another embodiment of the invention.

FIG. 9 is a cross-sectional view taken along line 9-9 of FIG. 8, according to another embodiment of the invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

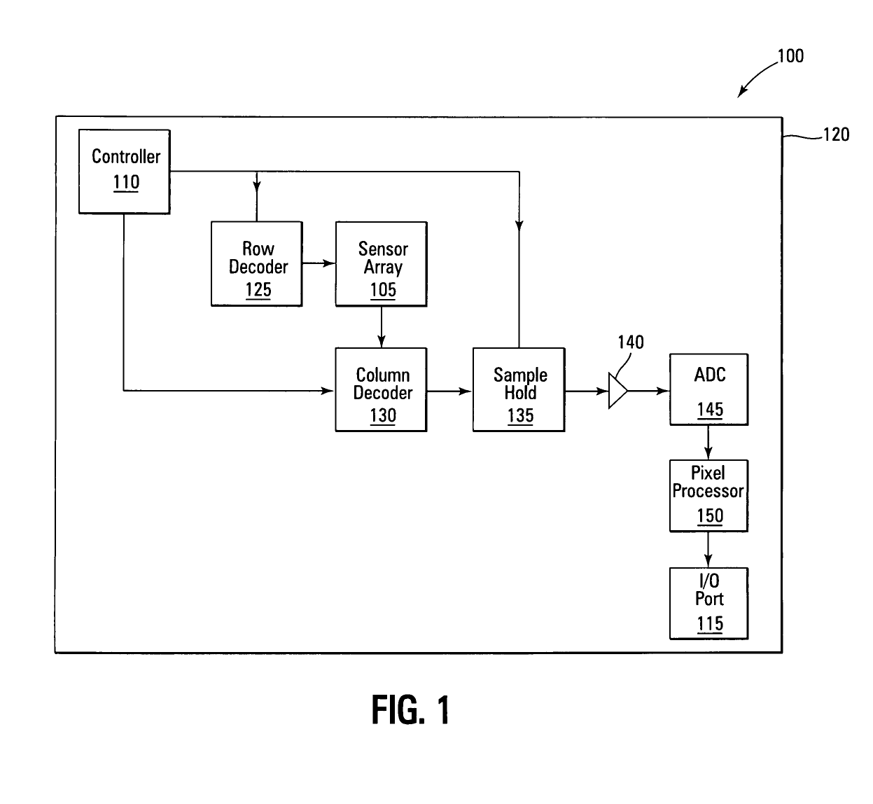

FIG. 1 is a block diagram of an image sensor 100, according to an embodiment of the invention. Image sensor 100 has a pixel sensor array 105, a controller 110, and an input/output port 115 with an associated interface. Image sensor 100 may be formed by a CMOS process on a semiconductor substrate 120 (e.g., silicon substrate) for one embodiment. Sensor array 105 includes pixels that may be formed with photodiodes or phototransistors, for another embodiment, as a light-sensing element. For one embodiment, a transparent cover is formed over sensor array 105, e.g., as part of a sensor array package. A gas- (e.g., an air-) containing gap separates a first surface of the cover that faces the pixels so that a first air-cover interface is formed. A second air-cover interface may also occur between a second surface of the cover that faces away from the pixels and air exteriorly of the pixels. The first and second surfaces of the cover are roughened to reduce reflections from the first and second air-cover interfaces in accordance with embodiments of the invention.

Controller 110 operates a row decoder 125, a column decoder 130, and other signals to enable read out of analog pixel signals from sensor array 105 to a sample-and-hold circuit 135, as known in the art. For one embodiment, the output of sample-and-hold circuit 135 may be amplified by an amplifier 140. The amplified output of sample-and-hold circuit 135 may be converted to digital signals by analog-to-digital converter 145 for another embodiment. For one embodiment, a pixel processor 150 digitally processes the pixel information and supplies it to I/O port 115.

It will be appreciated by those skilled in the art that additional circuitry and control signals can be provided, and that the image sensor of FIG. 1 has been simplified to help focus on the invention. It will further be understood that the above description of the image sensor of FIG. 1 is intended to provide a general understanding thereof and is not a complete description of all the elements and features of a typical image sensor.

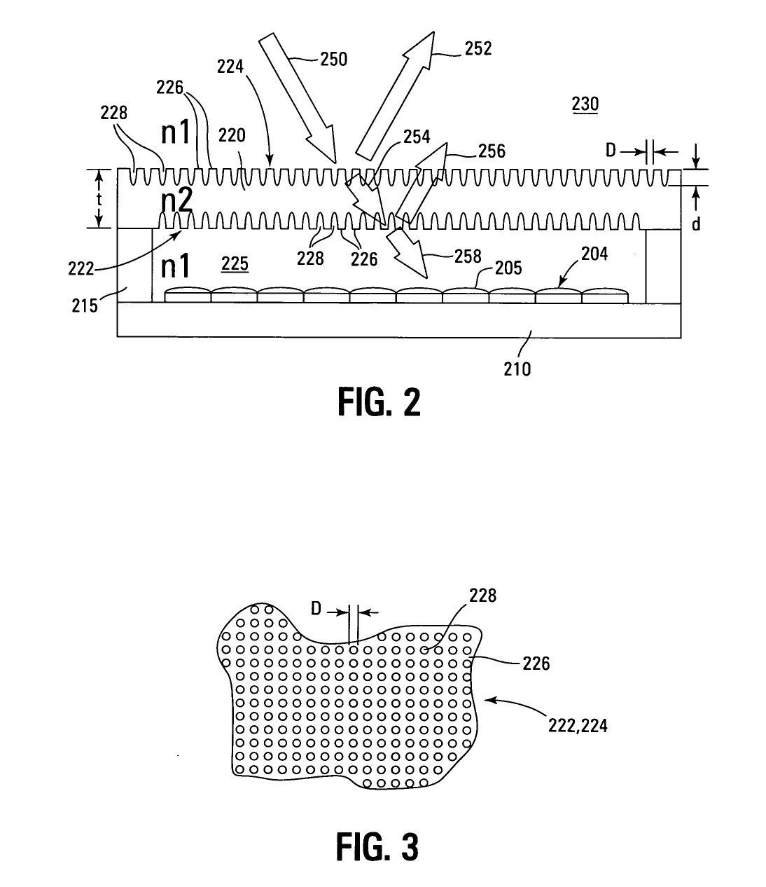

FIG. 2 is a cross-section of a portion of an image sensor, such as image sensor 100 of FIG. 1, according to another embodiment of the invention. For one embodiment, the image sensor may be a CCD image sensor, a CMOS image sensor, or the like. Image sensor includes a sensor array 204. Sensor array 204 includes pixels (or light-sensing elements) 205, such as photodiodes or phototransistors, formed on a substrate 210, such as a semiconductor substrate, e.g., of silicon or the like. A bond (or seal) ring 215 is formed on substrate 210 so as to extend above and surround sensor array 105. A transparent cover 220, e.g., of transparent glass, such as silicon dioxide, that can transmit visible light (electromagnetic radiation wavelengths of about 400 to about 700 nanometers) is formed overlying sensor array 105 in contact with bond ring 215. For one embodiment, cover 220 may be of a clear material, such as clear glass. For another embodiment, cover 220 may be of a tinted clear material. For one embodiment, cover 220 may be bonded to bond ring 215. For another embodiment, cover 220 may be a lens, such as a convex or a concave-convex lens. Cover 220 and bond ring 215 form an enclosure (or a package) that protects sensor array 204.

For one embodiment, the enclosure contains a gas 225, such as air, that overlies sensor array 105 and underlies cover 220. In other words, for some embodiments, a gas-containing gap separates a surface 222 of cover 220 from sensor array 204, as shown in FIG. 2. Note that gas 225 and cover 220 respectively have indices of refraction n1 (e.g., about 1.0 for air) and n2 (e.g., about 1.5 for glass) that are different from each other. For one embodiment, a gas 230, e.g., air, exteriorly of sensor array 204 overlies cover 220. For one embodiment, gases 225 and 230 are the same (e.g., both are air) and thus have the same index of refraction n1, as shown in FIG. 2. However, for other embodiments, gases 225 and 230 may be different from each other and thus have different indices of refraction. In any event, gases 225 and 230 will typically have indices of refraction that are different than the index of refraction of cover 220.

Note that surface 222 of cover 220 faces sensor array 204, and a surface 224 faces away from sensor array 105, as shown in FIG. 2. Surface 222 is in contact with gas 225, and surface 224 is in contact with gas 230. For one embodiment, surfaces 222 and 224 are roughened surfaces, each including peaks 226 and valleys 228. For one embodiment, peaks 226 correspond to portions of an original un-roughened surface of cover 220, and valleys 228 are discrete blind holes formed in that original un-roughened surface, as shown in FIG. 3, a plan view of surface 222 or 224, according to another embodiment of the invention.

For one embodiment, the blind holes corresponding to valleys 228 have an effective diameter D that is less than the wavelengths of visible light, e.g., less than about 400 nanometers, so as to avoid scattering of light passing through surface 222 or 224. For one embodiment, the blind holes, as viewed from the plan view of FIG. 3, e.g., as viewed perpendicularly to surface 222 or 224, may be circular, as shown in FIG. 3, square, triangular, etc. For some embodiments, the effective diameter D may be defined as four times the area of the blind hole at the plane of surface 222 or 224 divided by the perimeter surrounding that area. For other embodiments, the aspect ratio d/D of the blind holes (i.e., the ratio of the depth d (FIG. 2) of the blind holes to the effective diameter D to) is about 1 to about 5. For some embodiments, the depth d of the blind holes is about 2000 nanometers. For another embodiment, the depth d of the blind holes is about 1/500 to about 1/250 of the thickness t (FIG. 2) of cover 220. For one embodiment, the thickness t of cover 220 is about 0.5 millimeter.

In operation, incident light 250 is received at surface 224 of cover 220, as shown in FIG. 2. A first portion 252 of incident light 250 is reflected from surface 224, owing to the difference between the index of refraction n1 of gas 230, e.g., air, and the index of refraction n2 of cover 220. A second portion 254 of incident light 250 is transmitted through cover 220 and is incident on a backside of surface 222 of cover 220. A first portion 256 of second portion 254 of incident light 250 is reflected from surface 222, owing to the difference between the index of refraction n2 of cover 220 and the index of refraction n1 of gas 225, e.g., air. A second portion 258 of second portion 254 of incident light 250 is transmitted through gas 225 and is received at sensor array 204.

Note that the rate of change in the index of refraction between two optical media, e.g., cover 220 and air, results in reflections from the interface, e.g., the surface of cover 220, between the optical media, where the higher the rate of change the more reflection. For a smooth surface, there is an abrupt change in the index of refraction between the surface and the air, whereas for roughened surfaces, there is a gradual change in the index of refraction. Therefore, roughened surfaces 222 and 224 act to reduce the amount of light reflected from these surfaces compared to when these surfaces are smooth, and thus roughened surfaces 222 and 224 act to increase the amount of light received at sensor array 204.

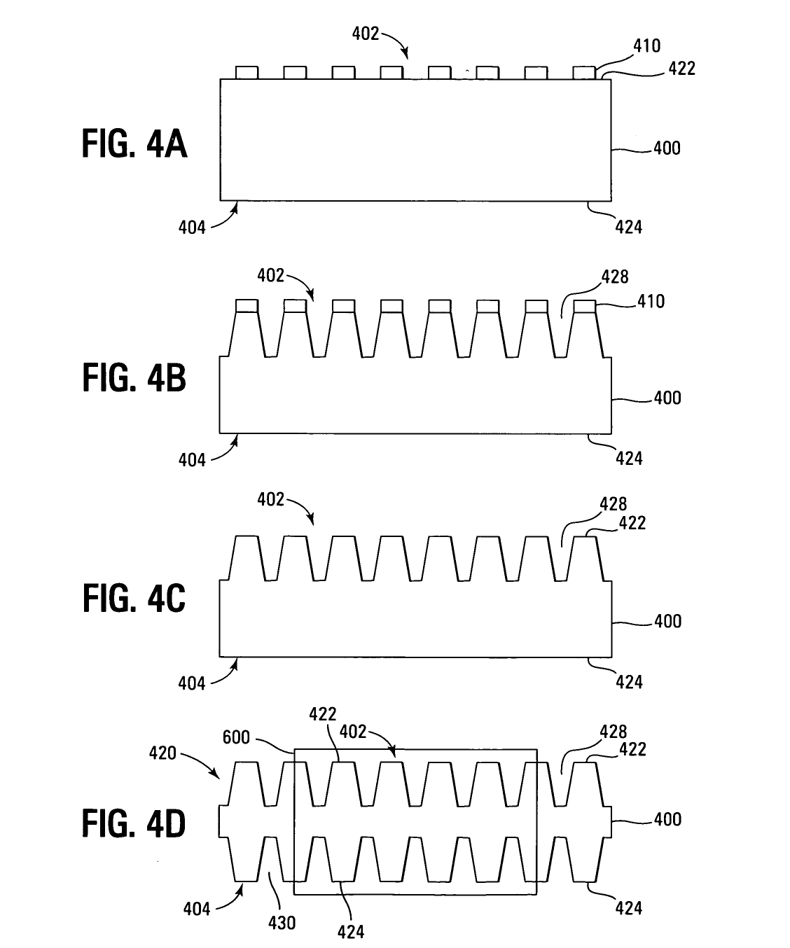

FIGS. 4A-4D are cross-sectional views that generally depict a method of forming a cover or a lens, such as cover 220 of FIG. 2, for a sensor array, such as sensor array 204 of FIG. 2, in accordance with one embodiment of the invention. In FIG. 4A, a patterned photoresist mask layer 410 is formed on a surface 422 of a side 402 of a transparent substrate 400, e.g., of clear glass, such as silicon dioxide, that can transmit visible light to expose areas of substrate 400 for removal. The exposed areas of substrate 400 are removed in FIG. 4B to form blind holes 428 in side 402 through surface 422 and into substrate 400. For one embodiment, an anisotropic dry etch, such as a reactive ion etch, removes the exposed areas of substrate 400. Mask layer 410 is subsequently removed in FIG. 4C. Note that blind holes 428 have substantially the same depth below surface 422 for another embodiment.

Subsequently, blind holes 430 are formed in a side 404, opposite side 402, through a surface 424 of substrate 400 and into substrate 400, as shown in FIG. 4D, using the method discussed above and depicted in FIGS. 4A-4C for forming blind holes 428. That is, a second patterned mask layer is formed on surface 424 to expose areas of substrate 400 for removal; the exposed areas of substrate 400 are removed, using an anisotropic dry etch, e.g., a reactive ion etch, to form blind holes 430 in side 404 through surface 424 and into substrate 400; and the second patterned mask layer is subsequently removed. This forms a cover (or a lens) 420, as shown in FIG. 4D. Note that blind holes 430 have substantially the same depth below surface 424 for another embodiment.

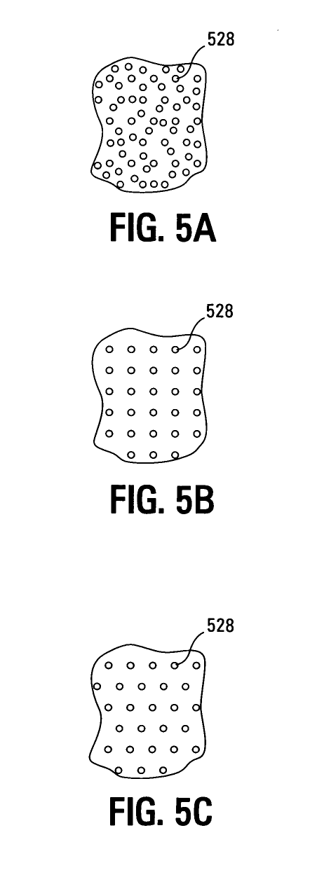

For various embodiments, the blind holes may be arranged in different patterns on the respective surfaces of the cover. For example, blind holes 528 may be arranged in a random pattern, as shown in FIG. 5A, a plan view of a surface of the cover, according to one embodiment. For another embodiment, blind holes 528 may be arranged in an in-line array pattern, as shown in FIG. 5B, a plan view of a surface of the cover. For another embodiment, blind holes 528 may be arranged in a staggered array pattern, as shown in FIG. 5C, a plan view of a surface of the cover.

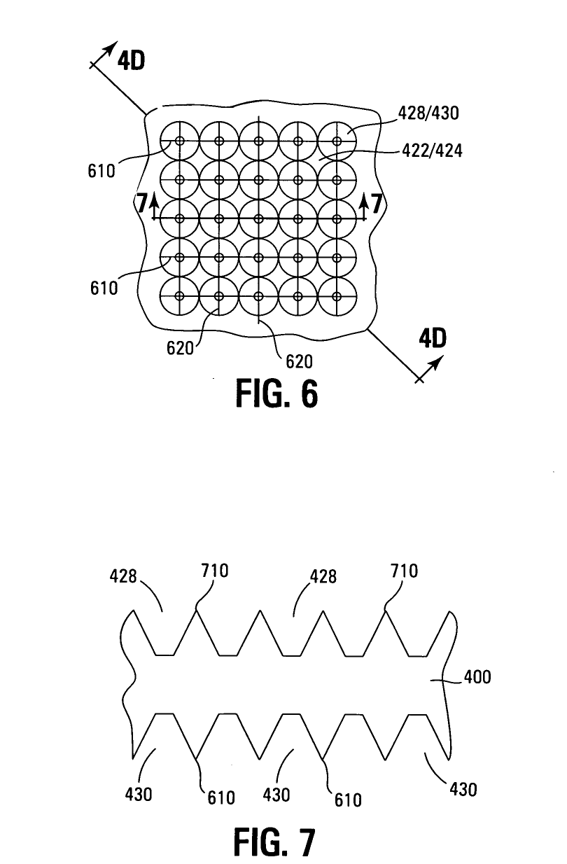

FIG. 6 is a plan view of a portion of surface 422/424 corresponding to the configuration of FIG. 4D, according to another embodiment of the invention. That is, region 600 of FIG. 4D is a cross-section viewed along the line 4D-4D of FIG. 6 for one embodiment. Note that for another embodiment, the circumferences of successively adjacent blind holes 428/430 intersect each other at a single point in the plane of surface 422/424, as shown in FIG. 6. That is, successively adjacent blind holes 428/430 are externally tangent to each other at a single point. Each intersection of the circumferences (or tangent point) of a pair of successively adjacent blind holes 428 corresponds to a sharpened peak (or point) 710 in FIG. 7, a cross-sectional view of taken along line 7-7, of FIG. 6.

Note that for in-line array configurations, such as the configuration of FIG. 6, the tangent points of successively adjacent blind holes 428/430 lie on lines 610 that are substantially parallel to rows of blind holes 428/430 and on lines 620 that are substantially parallel to columns of blind holes 428/430, as shown in FIG. 6. For the configuration of FIG. 6, the area occupied by blind holes 428/430 at the plane of surface 422/424 can be up to about 78 percent of the area of surface 422/424 before blind holes 428/430 are formed.

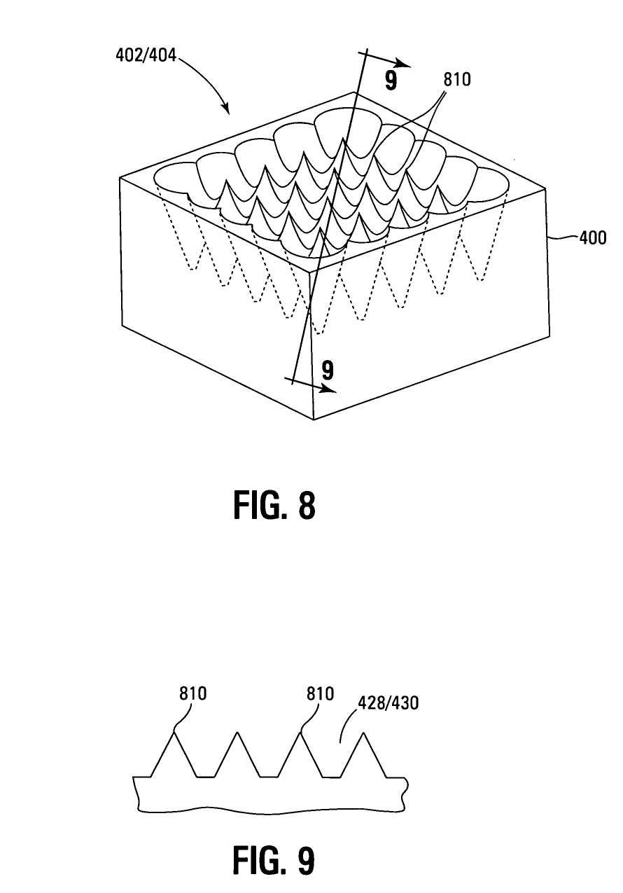

Note that portions of surface 422/424 separate successively adjacent blind holes 428/430 in a direction diagonal to the lines 610 and 620, i.e., diagonal to the column and row directions, and parallel to the line 4D-4D of FIG. 6, as shown in FIGS. 4D and 6. These portions of surface 422/424 are removed in FIGS. 8 and 9 to form sharpened (or pointed) spires 810 in side 402/404 of substrate 400, where FIG. 8 is an isometric plan view of a roughened side 402/404 (or surface) of cover or a lens, according to another embodiment of the invention and FIG. 9 is a cross-sectional view taken along line 9-9 of FIG. 8. Note that FIG. 9 is a portion of the cross-section of FIG. 4D after the portions of surface 422/424 that separate successively adjacent blind holes 428/430 in a direction diagonal to the column and row directions have been removed. For one embodiment, an isotropic etch is used to remove these portions of surface 422/424. Suitable isotropic etches include wet chemical isotropic etches and isotropic plasma etches, e.g., a sulfur hexafluoride/oxygen (SF₆/O₂) plasma etch.

For one embodiment, the spires 810 of FIGS. 8 and 9 are formed on one side, e.g., side 402, of the cover or lens, such as after forming the configuration of FIG. 4C, before forming the blind holes, e.g., blind holes 430 (FIG. 4D), on the opposite side, e.g., side 404, of the cover or lens. For example, for one embodiment, spires 810 may be formed after removing mask layer 410 from side 402, but before forming the mask layer on side 404. Spires 810 may then be formed on side 404 after forming blind holes 430 and after removing the mask layer from side 404.

### Conclusion

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. An image sensor, comprising:
an array of light sensing elements; and
a transparent cover overlying the array of light sensing elements;
wherein the cover has a first roughened surface facing the array of light sensing elements, and a second roughened surface facing away from the light sensing elements.

2. The image sensor of claim 1, wherein the light sensing elements are selected from the group consisting of photodiodes and phototransistors.

3. The image sensor of claim 1 further comprises a gas-containing gap interposed between the array of light sensing elements and the first roughened surface of the cover.

4. The image sensor of claim 1, wherein the first and second roughened surfaces each comprise a plurality of blind holes extending into the cover.

5. The image sensor of claim 4, wherein the blind holes of the first and second roughened surfaces have an effective diameter less than wavelengths of visible light.

6. The image sensor of claim 4, wherein the blind holes of the first roughened surface have the substantially the same depth and the blind holes of the second roughened surface have the substantially the same depth.

7. The image sensor of claim 4, wherein the blind holes are selected from the group consisting of circular, square, and triangular blind holes.

8. The image sensor of claim 4, wherein the blind holes have an aspect ratio of about 1 to about 5.

9. The image sensor of claim 4, wherein the blind holes are arranged on the first and second roughened surfaces in a pattern selected from the group consisting of a random pattern, an in-line array pattern, and a staggered array pattern.

10. The image sensor of claim 4, wherein the blind holes have a depth that is about 1/500 to about 1/250 of the thickness of the cover.

11. The image sensor of claim 4, wherein the plurality of blind holes of the respective first and second roughened surfaces occupy about 78 percent of the surface area of the respective first and second roughened surfaces.

12. The image sensor of claim 4, wherein successively adjacent blind holes, of the plurality of blind holes of the respective first and second roughened surfaces, are externally tangent to each other.

13. The image sensor of claim 1, wherein the first and second roughened surfaces each comprise a plurality of pointed spires.

14. An image sensor, comprising:
an array of light sensing elements formed on a substrate;
a bond ring formed on the substrate and surrounding the array of light sensing elements;
a transparent cover overlying the array of light sensing elements and overlying and in contact with the bond ring, the cover having a first surface facing the array of light sensing elements and a second surface facing away from the light sensing elements, a plurality of blind holes passing through each of the first and second surfaces and extending into the cover; and
an air gap interposed between the first surface of the cover and the array of light sensing elements and contained within the bond ring.

15. The image sensor of claim 14, wherein the transparent cover is of glass.

16. The image sensor of claim 15, wherein the transparent cover is clear.

17. The image sensor of claim 14, wherein the transparent cover is of silicon dioxide.

18. The image sensor of claim 14, wherein the image sensor is a Charged Coupled Device (CCD) image sensor or a Complementary Metal-Oxide Semiconductor (CMOS) image sensor.

19. The image sensor of claim 14, wherein the blind holes are selected from the group consisting of circular, square, and triangular blind holes.

20. The image sensor of claim 14, wherein each of the blind holes has an effective diameter of less than about 400 nanometers.

21. An image sensor, comprising:
a controller;
a row decoder coupled to the controller;
a column decoder coupled to the controller;
an array of light sensing elements coupled to the row and column decoders; and
a transparent cover overlying the array of light sensing elements;
wherein the cover has a first roughened surface facing the array of light sensing elements and a second roughened surface facing away from the light sensing elements.

22. The image sensor of claim 21 further comprises an analog-to-digital converter coupled between the column decoder and an input/output of the image sensor.

23. The image sensor of claim 22 further comprises an amplifier coupled between the analog-to-digital converter and the column decoder.

24. The image sensor of claim 22 further comprises a sample-and-hold circuit coupled between the analog-to-digital converter and the column decoder.

25. A method of forming a lens, comprising:
forming a first plurality of blind holes through a first surface of a transparent substrate that extend into the substrate; and
forming a second plurality of blind holes through a second surface of the substrate that extend into the substrate, wherein the second surface faces opposite the first surface.

26. The method of claim 25, wherein the first plurality of blind holes are formed prior to the second plurality of blind holes.

27. The method of claim 25, wherein each of the blind holes of the first plurality of blind holes and of the second plurality of blind holes have an effective diameter that is less than wavelengths of visible light.

28. The method of claim 25, wherein the blind holes of the first plurality of blind holes and the blind holes of the second plurality of blind holes are selected from the group consisting of circular, square, and triangular blind holes.

29. The method of claim 25, wherein the transparent substrate is silicon dioxide.

30. The method of claim 25, wherein the blind holes of the first plurality of blind holes and the blind holes of the second plurality of blind holes are respectively arranged on the first and second surfaces in a pattern selected from the group consisting of a random pattern, an in-line array pattern, and a staggered array pattern.

31. The method of claim 25, wherein the blind holes of the first plurality of blind holes and the blind holes of the second plurality of blind holes are selected from the group consisting of blind holes having a depth that is about 1/500 to about 1/250 of the thickness of the substrate and blind holes having a depth of about 2000 nanometers.

32. The method of claim 25, wherein the first and second pluralities of blind holes respectively occupy about 78 percent of the surface area of the first and second surfaces.

33. The method of claim 25, wherein successively adjacent blind holes of each of the first and second pluralities of blind holes are externally tangent to each other.

34. The method of claim 25 further comprises removing portions of the first surface between successively adjacent blind holes of the first plurality of blind holes and removing portions of the second surface between successively adjacent blind holes of the second plurality of blind holes.

35. The method of claim 34, wherein removing portions of the first surface between successively adjacent blind holes of the first plurality of blind holes and removing portions of the second surface between successively adjacent blind holes of the second plurality of blind holes each comprise an isotropic etch.

36. The method of claim 34, wherein removing portions of the first surface between successively adjacent blind holes of the first plurality of blind holes occurs before forming the second plurality of blind holes.

37. A method of forming a lens, comprising:
patterning a first surface of a transparent substrate to define first areas of the substrate for removal;
removing the first areas defined for removal using a first anisotropic etch to form first blind holes extending into the substrate;
after removing the first areas defined for removal, patterning a second surface of the substrate, opposite the first surface, to define second areas of the substrate for removal; and
removing the second areas defined for removal using a second anisotropic etch to form second blind holes extending into the substrate.

38. The method of claim 37, wherein the first and second anisotropic etches dry anisotropic etches.

39. The method of claim 37, wherein the first and second anisotropic etches are reactive ion etches.

40. The method of claim 37, wherein the effective diameter of the first and second blind holes is less than about 400 nanometers.

41. The method of claim 37 further comprises after removing the first areas defined for removal, but before patterning the second surface of the substrate, removing portions of the first surface between successively adjacent first blind holes.

42. The method of claim 41, wherein removing portions of the first surface between successively adjacent first blind holes comprises an isotropic etch.

43. The method of claim 42 further comprises after removing the second areas defined for removal, removing portions of the second surface between successively adjacent second blind holes.

44. The method of claim 43, wherein removing portions of the second surface between successively adjacent second blind holes comprises an isotropic etch.

45. A method of forming a lens, comprising:
forming a first mask layer on a first surface of a transparent substrate that can transmit visible light therethrough;
patterning the first mask layer to expose first areas of the substrate for removal;
removing the exposed first areas using a first reactive ion etch to form first blind holes extending into the substrate;
removing the first mask layer;
after removing the first mask layer, forming a second mask layer on a second surface of the substrate, opposite the first surface;
patterning the second mask layer to expose second areas of the substrate for removal;
removing the exposed second areas using a second reactive ion etch to form second blind holes extending into the substrate; and
removing the second mask layer.

46. A method of forming a lens, comprising:
forming a first mask layer on a first surface of a transparent substrate that can transmit visible light therethrough;
patterning the first mask layer to expose first areas of the substrate for removal;
removing the exposed first areas using a first anisotropic etch to form first blind holes extending into the substrate;
removing the first mask layer;
after removing the first mask layer, removing portions of the first surface between successively adjacent first blind holes using a first isotropic etch;
after removing portions of the first surface between successively adjacent first blind holes, forming a second mask layer on a second surface of the substrate, opposite the first surface;
patterning the second mask layer to expose second areas of the substrate for removal;
removing the exposed second areas using a second anisotropic etch to form second blind holes extending into the substrate;
removing the second mask layer; and
after removing the second mask layer, removing portions of the second surface between successively adjacent second blind holes using a second isotropic etch.

47. A method of packaging a sensor array of an image sensor, comprising:
surrounding the sensor array with a bond ring; and
affixing a transparent cover to the bond ring so that the cover overlies the sensor array;
wherein the cover has a first roughened surface facing the sensor array, and a second roughened surface facing away from the sensor array.

48. The method of claim 47, wherein affixing a transparent cover to the bond ring forms a gap between the cover and the sensor array.

49. The method of claim 48, wherein the gap contains air.

50. The method of claim 47, wherein the sensor array is selected from the group consisting of an array of light sensing elements, an array of photodiodes, and an array phototransistors.

51. The method of claim 47, wherein the first and second roughened surfaces each comprise a plurality of blind holes extending into the cover.

52. The method of claim 51, wherein the blind holes of the first and second roughened surfaces each have an effective diameter less than wavelengths of visible light.

53. A method of forming a portion of an image sensor, comprising:
forming an array of light sensing elements on a substrate;
forming a bond ring on the substrate that surrounds the array of light sensing elements;
roughening first and second surfaces of a transparent cover; and
affixing the transparent cover to the bond ring so that the cover overlies the sensor array with the first roughened surface facing the array of light sensing elements and the second roughened surface facing away from the array of light sensing elements;
wherein roughening the first and second surfaces of the transparent cover comprises:
forming a first plurality of blind holes through the first surface of the cover that extend into the cover; and
forming a second plurality of blind holes through the second surface of the cover that extend into the cover.

54. The method of claim 53, wherein each of the blind holes of the first plurality of blind holes and of the second plurality of blind holes have an effective diameter that is less than about 400 nanometers.

55. The method of claim 53, wherein the blind holes of the first plurality of blind holes and the blind holes of the second plurality of blind holes are selected from the group consisting of circular, square, and triangular blind holes.

56. The method of claim 53, wherein affixing the transparent cover to the bond ring forms a gas-containing gap between the first roughened surface and the array of light sensing elements.

57. A method of forming a portion of an image sensor, comprising:
forming an array of light sensing elements on a substrate;
forming a bond ring on the substrate that surrounds the array of light sensing elements;
roughening first and second surfaces of a transparent cover; and
affixing the transparent cover to the bond ring so that the cover overlies the sensor array to form an air gap between the first roughened surface and the array of light sensing elements, wherein the first roughened surface faces the array of light sensing elements and the second roughened surface faces away from the array of light sensing elements;
wherein roughening the first and second surfaces of the transparent cover comprises:
patterning the first surface of the cover to define first areas of the cover for removal;
removing the first areas defined for removal using a first anisotropic etch to form first blind holes extending into the cover;
after removing the first areas defined for removal, patterning the second surface of the cover to define second areas of the cover for removal; and
removing the second areas defined for removal using a second anisotropic etch to form second blind holes extending into the cover.

58. The method of claim 57, wherein the first and second anisotropic etches are dry anisotropic etches.

59. A method of forming a portion of an image sensor, comprising:
forming an array of light sensing elements on a substrate;
forming a bond ring on the substrate that surrounds the array of light sensing elements;
roughening first and second surfaces of a transparent cover that can transmit visible light therethrough; and
affixing the transparent cover to the bond ring so that the cover overlies the sensor array to form an air gap between the first roughened surface and the array of light sensing elements, wherein the first roughened surface faces the array of light sensing elements and the second roughened surface faces away from the array of light sensing elements;
wherein roughening the first and second surfaces of the transparent cover comprises:
forming a first mask layer on the first surface of the cover;
patterning the first mask layer to expose first areas of the cover for removal;
removing the exposed first areas using a first reactive ion etch to form first blind holes extending into the cover;
removing the first mask layer;
after removing the first mask layer, forming a second mask layer on the second surface of the cover;
patterning the second mask layer to expose second areas of the cover for removal;
removing the exposed second areas using a second reactive ion etch to form second blind holes extending into the substrate; and
removing the second mask layer.

60. A method of forming a portion of an image sensor, comprising:
forming an array of light sensing elements on a substrate;
forming a bond ring on the substrate that surrounds the array of light sensing elements;
roughening first and second surfaces of a transparent cover that can transmit visible light therethrough; and
affixing the transparent cover to the bond ring so that the cover overlies the sensor array to form an air gap between the first roughened surface and the array of light sensing elements, wherein the first roughened surface faces the array of light sensing elements and the second roughened surface faces away from the array of light sensing elements;
wherein roughening the first and second surfaces of the transparent cover comprises:
forming a first mask layer on the first surface of the cover;
patterning the first mask layer to expose first areas of the cover for removal;
removing the exposed first areas using a first anisotropic etch to form first blind holes extending into the cover;
removing the first mask layer;
after removing the first mask layer, removing portions of the first surface between successively adjacent first blind holes using a first isotropic etch;
after removing portions of the first surface between successively adjacent first blind holes, forming a second mask layer on the second surface of the cover;
patterning the second mask layer to expose second areas of the cover for removal;
removing the exposed second areas using a second anisotropic etch to form second blind holes extending into the substrate;
removing the second mask layer; and
after removing the second mask layer, removing portions of the second surface between successively adjacent second blind holes using a second isotropic etch.
